(19) United States
(12) Patent Application Publication
(10) Pub. No.: US 2026/0210340 A1
(43) Pub. Date: Jul. 23, 2026

(54) SHAPE MEMORY ALLOY-DRIVEN DOUBLE-HELICAL DUAL-VALVE-ACTION HYDRODYNAMIC DRIVE FOR SOFT ROBOTIC APPLICATIONS IN AQUEOUS ENVIRONMENTS

(71) Applicant: Arizona Board of Regents on Behalf of the University of Arizona, Tucson, AZ (US)

(72) Inventors: Wolfgang Fink, Tucson, AZ (US); Andres Nuncio Zuniga, Tucson, AZ (US)

(21) Appl. No.: 19/138,974

(22) PCT Filed: Dec. 18, 2023
(86) PCT No.: PCT/US2023/084687

§ 371 Date: Jun. 13, 2025

Related U.S. Application Data
(60) Provisional application No. 63/433,483, filed on Dec. 18, 2022.
(60) Provisional application No. 63/482,385, filed on Jan. 31, 2023.

(51) Int. Cl. F03G 7/00; B63H 11/04; F03G 7/06; F04B 43/08; F04B 53/10

(52) U.S. Cl. CPC F03G 7/0254; B63H 11/04; F03G 7/06145

(57) ABSTRACT

Various examples are provided related to hydrodynamic drives and their applications. In one example, a hydrodynamic drive includes a flexible body having an interior chamber extending between a first end and a second end. The flexible body includes an actuated helical coil extending between the first end and the second end, where activation of the actuated helical coil contracts the flexible body and deactivation of the actuated helical coil allows expansion of the flexible body. The first or second end can include at least one opening. For example, the hydrodynamic drive can include inlet and outlet valves on the first and second ends of the flexible body. A soft robotic system can include at least one hydrodynamic drive that operates as a pump or thruster.

### CROSS REFERENCE TO RELATED APPLICATIONS

This application claims priority to, and the benefit of, U.S. provisional applications entitled “Shape Memory Alloy-Driven Double-Helical Dual-Valve-Action Hydrodynamic Drive for Soft Robotic Applications in Aqueous Environments” having Ser. No. 63/433,483, filed Dec. 18, 2022, and Ser. No. 63/482,385, filed Jan. 31, 2023, both of which are hereby incorporated by reference in their entireties.

### STATEMENT REGARDING FEDERALLY SPONSORED RESEARCH OR DEVELOPMENT

This invention was made with government support under grant number 5T32GM132008-02 awarded by the National Institutes of Health and grant number 1809591 awarded by the National Science Foundation. The Government has certain rights in the invention.

### BACKGROUND

Robotic systems have been ubiquitous for over half a century with varying levels of sophistication, automation, and autonomy. However, most robotic systems have been characterized by rigid or “stiff” structures, limbs, actuators, or components, i.e., they are neither able to adapt, flex, deform, or shape-change, nor able to navigate, negotiate, infiltrate, or explore (narrow) environments, e.g., cracks and crevices, ship wrecks, containers, caves, etc.

### SUMMARY

Aspects of the present disclosure are related to hydrodynamic drives and their applications. In one aspect, among others, a hydrodynamic drive comprises a flexible body having an interior chamber extending between a first end and a second end, the flexible body comprising an actuated helical coil extending between the first end and the second end, where activation of the actuated helical coil contracts the flexible body and deactivation of the actuated helical coil allows expansion of the flexible body. In one or more aspects, the first end can be closed off and the second end can comprise an opening. In other aspects, the hydrodynamic drive can comprise inlet and outlet valves on the first and second ends of the flexible body, where the outlet valve is configured to allow discharge of fluid from the interior chamber of the flexible body during contraction and to prevent re-entrance of fluid to the interior chamber of the flexible body during expansion, and the inlet valve is configured to prevent discharge of fluid from the interior chamber of the flexible body during contraction and to allow entrance of fluid to the interior chamber of the flexible body during expansion.

In various aspects, the actuated helical coil can be electrically or thermally actuated. The flexible body can comprise a second helical coil extending between the first end and the second end, wherein the second helical coil expands the flexible body when the actuated helical coil is deactivated. The second helical coil can be a passive coil. The second helical coil can be an actuated helical coil that is electrically or thermally actuated.

The second helical coil can be compressed by the actuated helical coil during activation and released when the actuated helical coil is deactivated. The actuated helical coil and the second helical coil can be wound in opposite directions. In some aspects, the inlet and outlet valves can be one-way valves. The inlet and outlet valves can be duckbill valves. The inlet valve and outlet valve can each comprise a backstop grating. The actuated helical coil can comprise a shape memory alloy, wherein electrical or thermal activation of the shape memory alloy causes the actuated helical coil to contract from its initial shape and subsequent deactivation allows the actuated helical coil to return to its initial shape. The shape memory alloy can be an electrically or thermally activated shape memory alloy. The passive helical coil can be a steel spring or plastic spring.

In another aspect, a soft robotic system comprises at least one hydrodynamic drive including one or more aspects provided above. The at least one hydrodynamic drive can operate as a pump or thruster. In one or more aspects, the soft robotic system can comprise a plurality of hydrodynamic drives. The plurality of hydrodynamic drives can be positioned in different orientations, wherein the plurality of hydrodynamic drives can be individually controllable to provide directional thrust for propulsion or rotational thrust for reorientation of the soft robotic system. In various aspects, the soft robotic system can comprise control circuitry configured to individually control operation of each of the plurality of hydrodynamic drives. The plurality of hydrodynamic drives can be distributed in a triangular arrangement. The plurality of hydrodynamic drives can be distributed about a central housing. The soft robotic system can comprise control circuitry configured to control operation of the at least one hydrodynamic drive. The control circuitry can be configured to control operation of the at least one hydrodynamic drive based at least in part upon sensed orientation or location of the soft robotic system. The control circuitry can comprise an orientation sensor, a temperature sensor, and/or a pressure sensor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C illustrate examples of a hydrodynamic drive, in accordance with various embodiments of the present disclosure.

FIG. 2 includes images of 3D-printed molds and double molds that can be used for the formation of a skin or hull for a hydrodynamic drive, in accordance with various embodiments of the present disclosure.

FIGS. 3A and 3B illustrate an example of inlet and outlet valves of a hydrodynamic drive, in accordance with various embodiments of the present disclosure.

FIGS. 4A-4D and 5A-5C illustrate operation of a hydrodynamic drive, in accordance with various embodiments of the present disclosure.

FIGS. 6A and 6B illustrate an example of a soft robotic system comprising hydrodynamic drives, in accordance with various embodiments of the present disclosure.

FIG. 7 illustrates an example of onboard electronic control circuitry of a soft robotic system, in accordance with various embodiments of the present disclosure.

FIGS. 8A-8C illustrate an example of a soft robotic system with a triangular “octopus-like” arrangement of hydrodynamic drives, in accordance with various embodiments of the present disclosure.

FIG. 9 illustrates examples of firing or activation schemes to effectuate rotations, directional, translational, or motion changes of the soft robotic system, in accordance with various embodiments of the present disclosure.

FIG. 10 illustrates an actual firing or activation of a soft robotic system with a triangular “octopus-like” arrangement of hydrodynamic drives, in accordance with various embodiments of the present disclosure.

FIG. 11A-11D illustrate another example of a hydrodynamic drive with a single opening that serves as both inlet and outlet, as well as the operation of this hydrodynamic drive, in accordance with various embodiments of the present disclosure.

### DETAILED DESCRIPTION

Disclosed herein are various examples related to hydrodynamic drives and their applications in, e.g., soft robotics for aqueous environments. Reference will now be made in detail to the description of the embodiments as illustrated in the drawings, wherein like reference numbers indicate like parts throughout the several views.

A new field of robotics has emerged: the field of soft robotics, which has many potential applications areas, such as, but not limited to: industry, (advanced) manufacturing, exploration, reconnaissance/surveillance, space exploration (especially ocean worlds, such as Europa, Enceladus, Titan, etc.), resource prospecting, military payload delivery, military robotics, maritime robotics, search & rescue, and research, prosthetics, e.g., prosthetic limbs, skin, organs (e.g., heart, lung), muscles, muscle support structures, organ support structures (e.g., for heart failure/insufficiency, lung failure/insufficiency), support structures for other body parts, and other/additional medical applications. With particular regard to prosthetics, most recently, soft robotic structures, such as sleeves, have been developed, e.g., to support the beating of a heart after heart failure by wrapping around the heart like a sock around a foot or a glove around a hand. Along the same lines it is conceivable to replace lung tissue with, or to wrap around lung tissue a soft robotic tissue to support lung function/tissue to overcome lung operational insufficiencies/deficiencies.

For the purposes of reconnaissance/surveillance, exploration, prospecting, search & rescue, military, and payload transport and delivery operations in aqueous/aquatic/riverine/lacustrine/maritime environments, as well as for potential medical and prosthetic applications, a novel propulsion mechanism based on a pump/thruster that is motor-less and actuator-less, and deployable at arbitrary depths, i.e., pressure-resistant (immune to high pressure), is disclosed. Moreover, from a military point of view, this propulsion method does not generate sound (e.g., cavitation) and has a very attenuated, localized heat-signature as, e.g., a large ocean acts as an infinite heat bath to completely absorb and thereby hide the local periodic heating of the pump/thrusting mechanism, thereby severely attenuating the heat signature, especially over short distances, i.e., rapid temperature drop-off. As such, this hydrodynamic drive is relatively undetectable or undetectable, e.g., at larger distance. The disclosed disruptive pump/thruster design does not use a motor or actuator. As such, the pump/thruster can operate in a wide range of liquid environments, including, but not limited to, liquid environments characterized by high pressures and/or very low temperatures, e.g., as can be found in terrestrial oceans and on ocean worlds, e.g., Europa, Enceladus, Titan, etc. In particular, it can be used as (1) a novel propulsion system for marine applications, and (2) as an implantable pump for medical/biomedical applications.

Examples of mechanisms, technologies, and technology implementations that can be used to realize an autonomous soft robotic system that exhibits octopus-/squid-like characteristics include, e.g.:
Use of an asymmetric tube pumping mechanism (e.g., peristalsis) can provide a directional propagation mechanism under water. The pumping force can be exerted by an artificial and/or biological muscle ring (e.g., through periodic contraction and expansion);
Octopus- or squid-like mechanical propulsion;
Jellyfish-like mechanical propulsion;
Bi-metals (potentially electrically controlled) for limb or arm actuation;
Pneumatic or hydraulic systems, e.g., inflating or deflating a tube with a fluid (e.g., liquid, oil, water, gas) or vacuum;
Internal thrusters and/or pumps to create thrust or a jet stream; and/or
Potential bionic/cyborg-based propulsion, i.e., taking (heart) muscle cells or other cells or organic components from animals or organisms, and incorporating them into the body/arm structure of the soft robotic system.

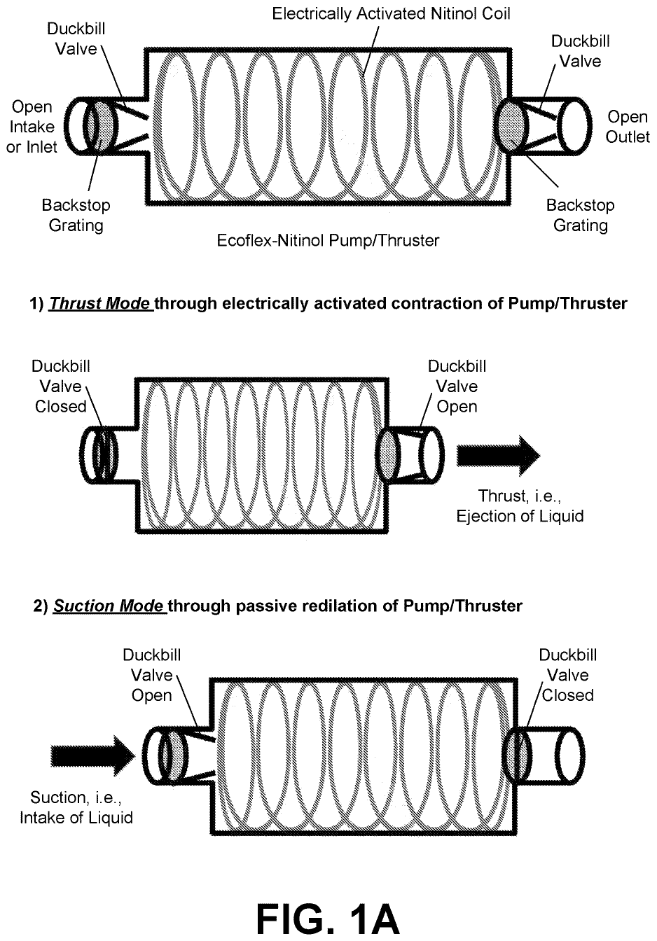

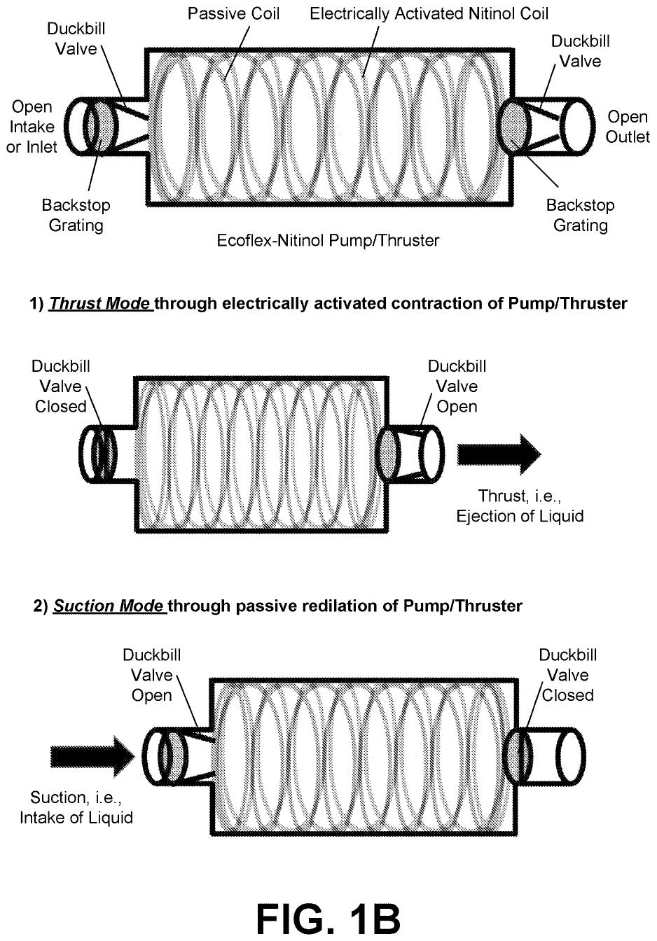

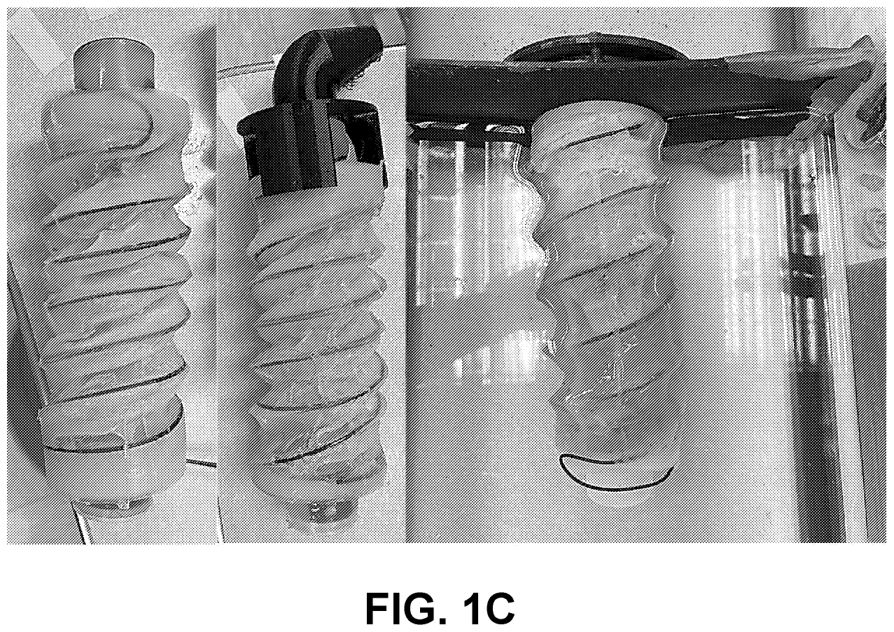

With these in mind, a hydrodynamic drive, e.g., for underwater propulsion, was developed and utilized in the design of a soft robot for operation in an aqueous environment. A plurality of hydrodynamic drives can be configured to provide controllable thrust for movement (e.g., translational movement) and spatial orientation (e.g., rotation) in the aqueous environment. Examples of a hydrodynamic drive are schematically illustrated in FIGS. 1A and 1B. The hydrodynamic drive comprises a flexible body having an interior chamber extending between a first end and a second end. The body can be formed by a flexible skin or hull extending over one or more coils, which can include, e.g., an electrically or thermally actuated coil or spring, or a pair of coils including an electrically or thermally actuated coil or spring, and a passive coil or spring. In some embodiments, the pair of coils can include two electrically or thermally actuated coils or springs.

FIG. 1A illustrates an example of a hydrodynamic drive with a single electrically actuated coil and FIG. 1B illustrates an example of a hydrodynamic drive with an electrically actuated coil and a passive coil. The hydrodynamic drive can include the two coil system with the passive coil (or with a second actuated coil instead of the passive coil) to assist in the redilation phase as shown in FIG. 1B. The added coil can increase efficiency and control of operation of the hydrodynamic drive. The hydrodynamic drive can also be implemented as a single coil system as shown in FIG. 1A with an electrically or thermally actuated coil without a passive coil or second actuated coil. This can offer cost savings during manufacturing and/or simplification of the manufacturing.

The electrically or thermally actuated coil can comprise a shape memory alloy (e.g., nitinol wire) that deforms when electrically or thermally activated and returns to its original shape after being deenergized. Electric actuation refers to electric current passing through the shape memory alloy which causes the alloy to heat up because of its intrinsic resistance to the current. This heat-up causes the shape memory alloy to change shape. The same or similar shape change can be effectuated by changing the temperature of the Shape memory alloy by other means, e.g., external heat-up. The electric current passing through the shape memory alloy can generate heat (because of the intrinsic resistance to the current) that produces the contraction of the coil. The passive coil can be a spring, such as, e.g., a steel or plastic spring. For example, energizing the electrically or thermally actuated coil can compress the passive spring and the flexible body until the electrically or thermally actuated coil is deenergized, after which the passive spring will return or assist in returning the hydrodynamic drive to its original shape. While the electrically or thermally actuated coil will return to its original shape by itself once it is deenergized (potentially over a different time span than the contraction, i.e., differential between contraction and redilation speeds/time), the passive spring can expedite/assist the return of the hydrodynamic drive to its original shape. In another example the flexible body or hydrodynamic drive can be formed by a single actuated coil (e.g., electrically or thermally actuated) whereby the inherent flexibility of the flexible skin or hull acts as the restoring or supporting/expediting coil-like force to attain the original shape of the body when the actuated coil is deenergized.

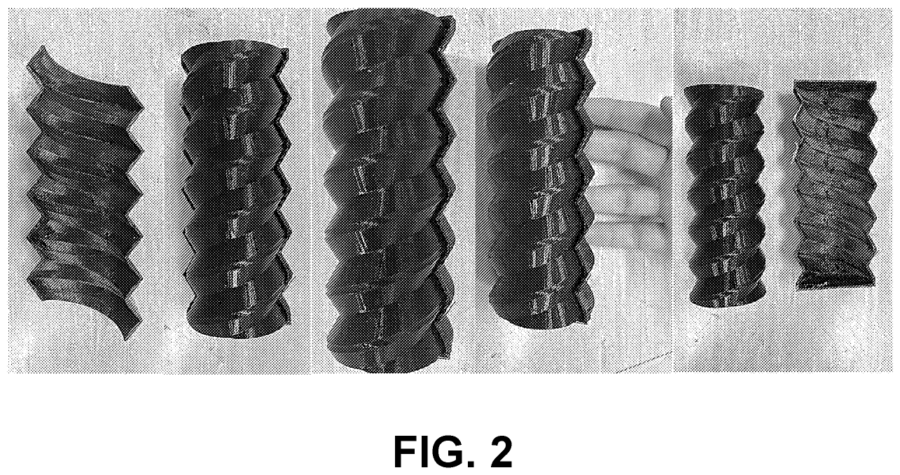

Referring to FIG. 1B, shown are images of a fabricated prototype of a hydrodynamic drive which can be utilized as a pump or thruster. The fabricated hydrodynamic drive comprises a skin or hull formed of a polymer or silicone rubber (e.g., Ecoflex), an electrically (or thermally) actuated coil of a shape memory alloy (e.g., a nitinol wire) for electrically (or thermally) activated contraction, and a passive coil (e.g., steel or plastic spring) for redilation or supporting/expediting redilation of the hydrodynamic drive. FIG. 2 includes images of 3D-printed molds and double molds that can be used for the formation of the skin or hull. Using the 3D-printed molds and Ecoflex material, the skin or hull for the prototype hydrodynamic drive was produced. The electrically actuated coil was formed using nitinol wire. Instead of Ecoflex, other silicone rubbers can be used alternatively.

The hydrodynamic drive can generate thrust by temporally asymmetric compression/redilation, e.g., a faster compression via the electrically or thermally actuated coil followed by a slower redilation via the passive coil, or vice versa.

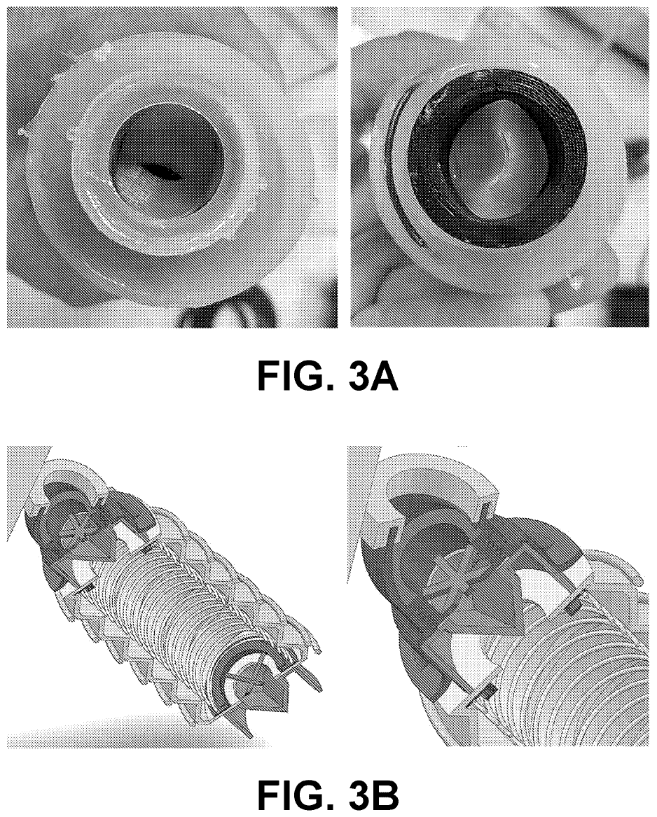

To support dual action, the hydrodynamic drive can comprise one-way valves (e.g., check valves) as inlet and outlet valves at the ends of the flexible body to facilitate dual action operation. As shown in FIG. 3A, the fabricated prototype was equipped with two duckbill valves as the outlet valve (right) for thrusting or pumping during contraction and the inlet valve (left) for suction during redilation. Backstop gratings can be included to prevent inversion of the duckbill valves during the respective valve closing action. FIG. 3B illustrates the placement of the backstop gratings with the duckbill valves. As shown in FIG. 1A, activation of the electrically actuated coil contracts the flexible body ejecting liquid in the inner chamber through the outlet valve during a thrust mode, and passive redilation of the flexible body sucks fluid into the inner chamber through the inlet valve during a suction mode. The backstop gratings can prevent pressure difference across the duckbill valves from inverting the valves which could cause unintended backflow or leakage resulting in reduced thrust.

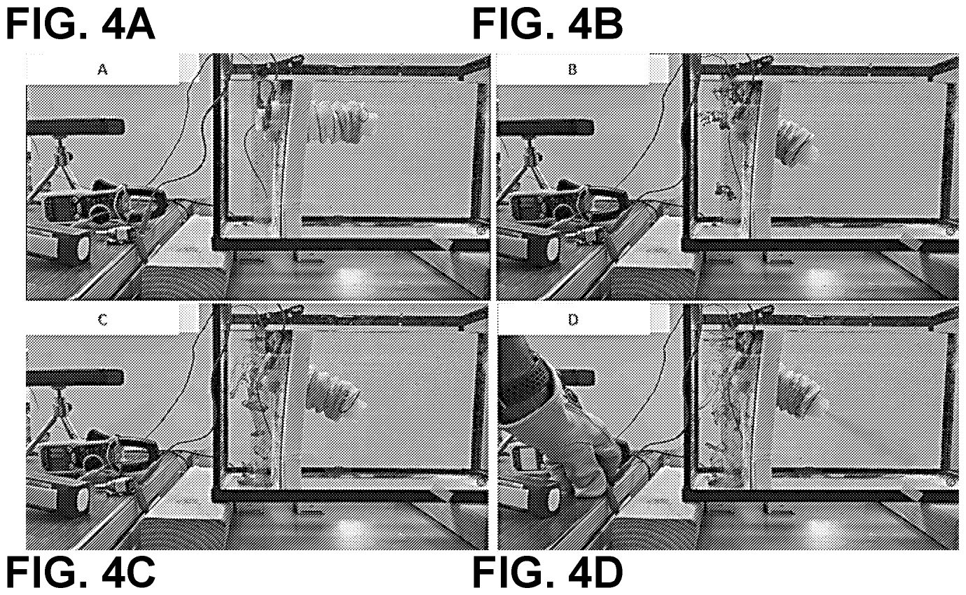

Testing was carried out to examine the operation of the hydrodynamic drive in an aqueous environment. FIGS. 4A-4D show the hydrodynamic drive affixed to a barrier separating an inlet area and a discharge area. FIG. 4A shows the hydrodynamic drive prior to activation of the electrically actuated coil. In FIG. 4B, the hydrodynamic drive has been contracted by the electrically actuated coil and a green dye has been added to the water in the inlet area. As shown in FIG. 4C, when the electrically actuated coil is deactivated the hydrodynamic drive sucks in the dyed water during redilation. As seen in FIG. 4D, reactivation of the electrically actuated coil contracts the hydrodynamic drive ejecting the dyed water into the discharge area.

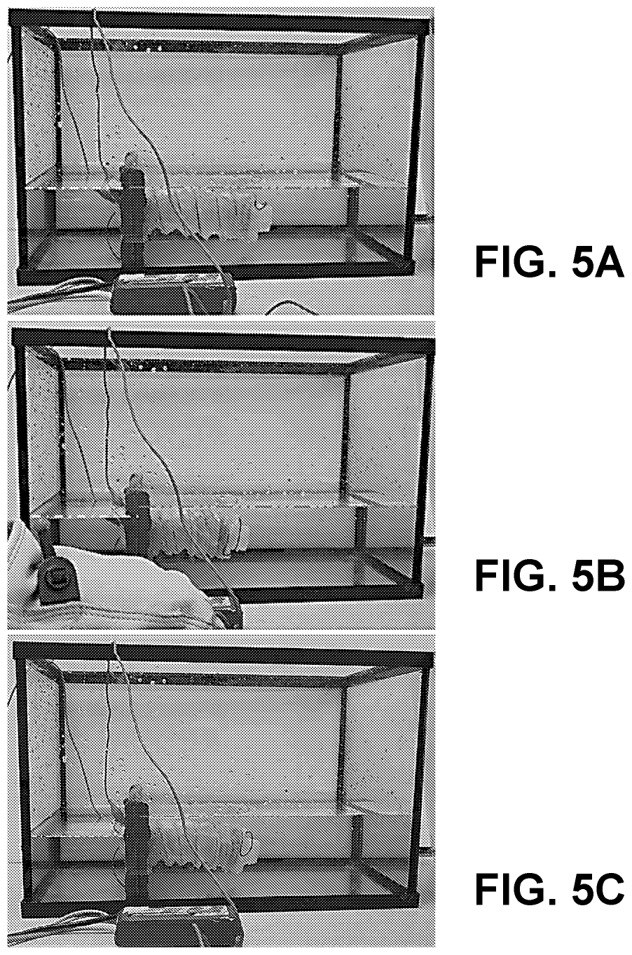

FIGS. 5A-5C illustrates actual pumping performance of the hydrodynamic drive. FIG. 5A shows the hydrodynamic drive submerged in the tank divided into left and right compartments by a sealed wall which includes the hydrodynamic drive before pumping, FIG. 5B shows the water levels in the left and right compartments of the tank after four cycles of contraction and redilation of the hydrodynamic drive, and FIG. 5C shows the water levels in the left and right compartments of the tank after eight cycles of contraction and redilation of the hydrodynamic drive. The water levels across the barrier started at the same height as shown in FIG. 5A, before terminating at a height difference of 2.1 cm as shown in FIG. 5C.

Based on the measured width (20.5 cm) and length (39.5 cm) of the tank and the position of the barrier (10.5 cm from left side), this amounts to more than a liter of water over the whole 8 cycles of contraction and redilation of the hydrodynamic drive, while fighting against increasing pressure during the contraction phase, i.e., ejection of water into the right compartment, due to an increase in water level in the right compartment.

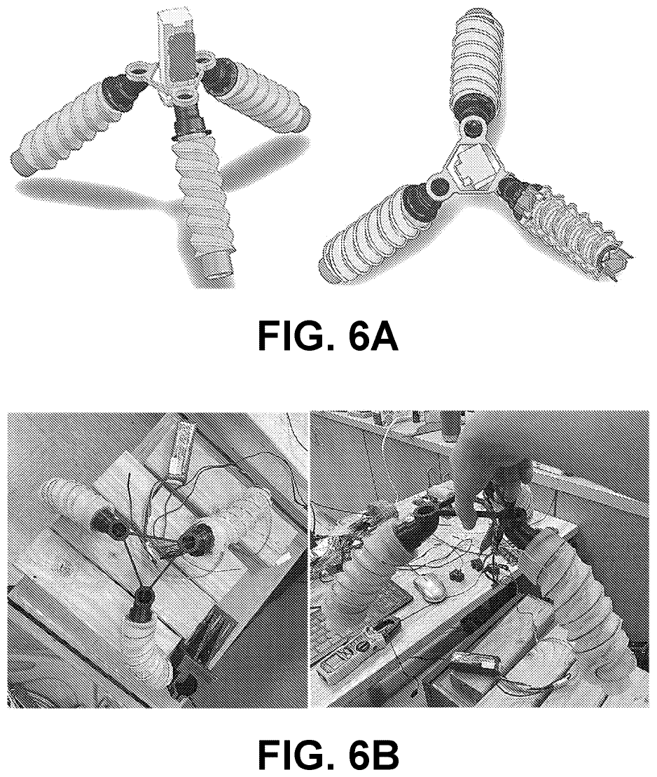

Referring next to FIGS. 6A and 6B, shown is an example of a soft robotic system comprising three hydrodynamic drives. FIG. 6A schematically illustrates a design of the soft robotic system and FIG. 6B includes images of an implemented prototype. While the example includes three hydrodynamic drives oriented/spatially arranged in a triangular arrangement, other numbers of hydrodynamic drives (e.g., one, two, or more) and/or orientations/spatial arrangements can be utilized. The hydrodynamic drives are arranged with the inlet valves adjacent to a central housing and the outlet valves at distal ends away from the central housing. Using three hydrodynamic drives oriented in the triangular arrangement can yield and effectuate a fully articulated/maneuverable system for both translational and rotational operations as will be discussed.

During the contraction phase of a hydrodynamic drive, the outlet valve opens for thrusting action, but the inlet valve closes at the same time to avoid leakage in the opposite direction. Conversely, during the redilation phase, the outlet valve closes to avoid leakage in the opposite direction and the inlet valve opens for sucking/intake action. The three hydrodynamic drives in the triangular arrangement can be activated in any of the following ways:
All three hydrodynamic drives can be activated at the same time, resulting in a mostly forward-oriented propulsion or translation of the soft robotic system;
Any two out of the three hydrodynamic drives can be activated at the same time, resulting in a stronger turn and/or rotation of the soft robotic system; or
Any one out of the three hydrodynamic drives can be activated, resulting in a weaker turn and/or rotation of the soft robotic system.
   It should be noted that when more than one hydrodynamic drive is activated, this activation can occur in a sequential rather than simultaneous manner, or in a pulsed manner, or in an alternating manner.

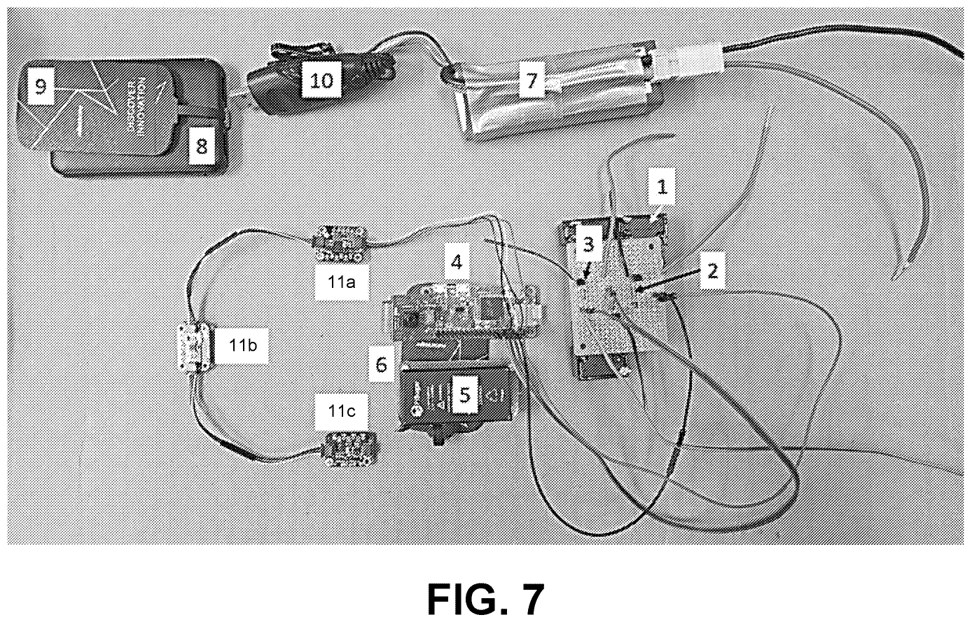

The soft robotic system can comprise electronic control circuitry configured to individually and/or collectively control operation of the hydrodynamic drives. FIG. 7 shows an example of onboard electronics that can operate and/or control a pump/thruster-equipped “octopus-like” soft robotic system, comprising three hydrodynamic drives (FIGS. 6A and 6B). The control circuitry can comprise relays (1), resistors (2), and transistors (3) for controlling power application to the electrically actuated coils. Processing circuitry can be implemented by a processor and memory such as, e.g., a microprocessor, microcontroller, or single-board computer (e.g., Raspberry Pi Zero W) (4). Power for the control circuitry can be provided by a battery or other power source (5), which may be configured to be recharged wirelessly using a wireless charging receiver (6). A separate battery (7) can be used to energize the electrically actuated coils. The battery (7) can be recharged using a portable power bank (8) or wireless charging receiver (9) with a power adapter cable (10). The wires represent connections to a microcontroller, such as, e.g., a Raspberry Pi's 5V and GND pins. Pins on the relays (1) which are not connected can be routed to the battery (7), which will activate contraction of respective hydrodynamic drives. Control of the hydrodynamic drives can be based upon sensor information from one or more sensors, such as, e.g., an orientation sensor (11a), a temperature sensor (11b), a pressure sensor (11c), or another sensor.

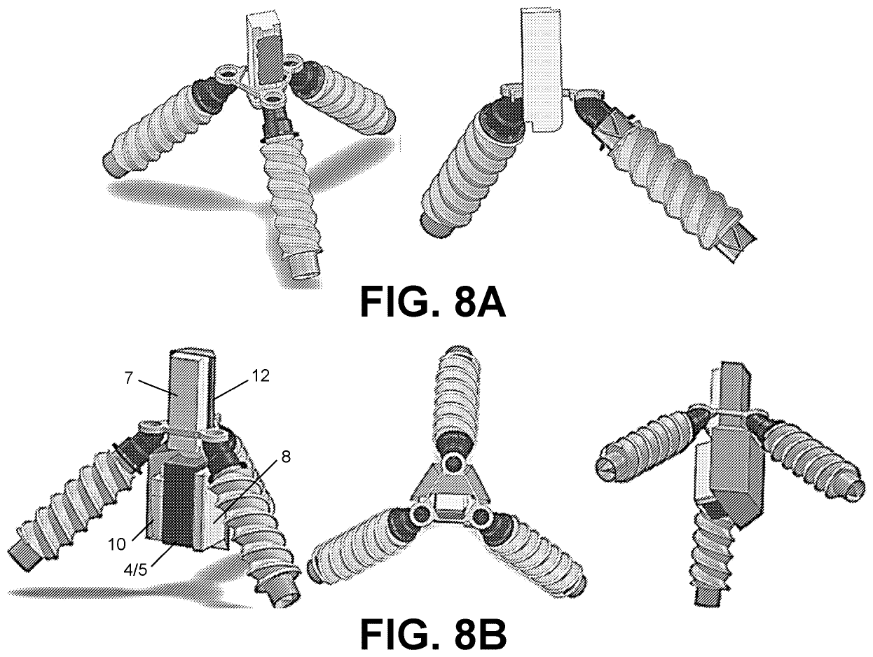

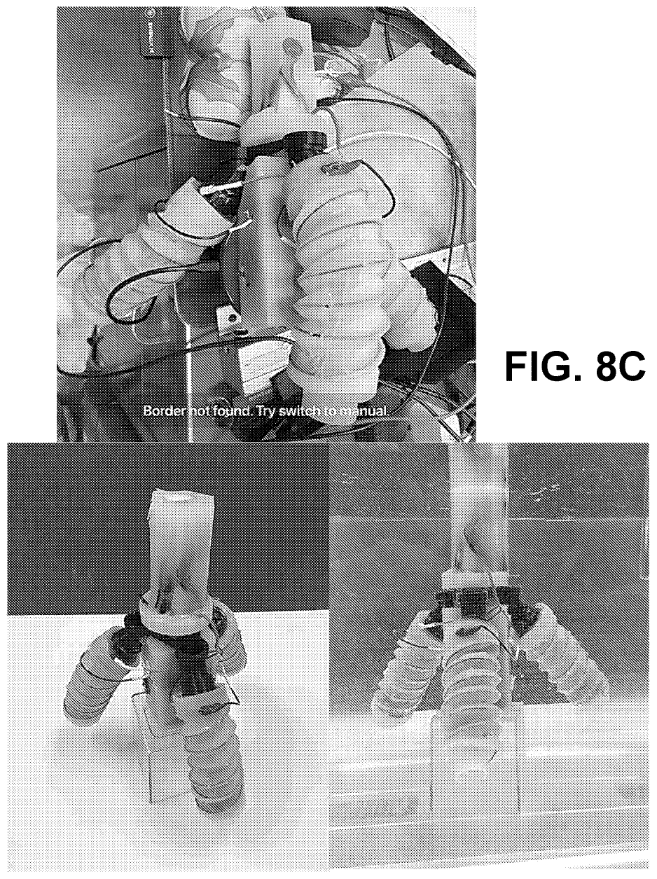

FIGS. 8A-8C illustrate an example of a soft robotic system with three hydrodynamic drives in a triangular “octopus-like” arrangement. Using three hydrodynamic drives in a triangular configuration as shown in FIGS. 6A and 6B and incorporating the onboard electronics of FIG. 7 encapsulated in a silicone rubber (e.g., Ecoflex) can provide the design/layout/architecture of a fully assembled soft robotic explorer for aqueous environments. FIG. 8C includes images of an assembled, fully functional prototype of the “octopus-like” soft robotic system.

FIG. 8A is a schematic diagram illustrating the hydrodynamic drive-equipped “octopus-like” soft robotic system control head comprising a Turnigy 2.2 battery (7), a Raspberry Pi Zero W (4) with relays (1), and auxiliary batteries which charge up the Turnigy 2.2 battery or supply power to the Raspberry Pi Zero W. The Raspberry Pi Zero W supplies power to a triad of high-current relays (1), which permit the flow of electric current from the Turnigy 2.2 to the electrically actuated coils of the hydrodynamic drives. Water gets suctioned through the inlet valve at a proximal end of the hydrodynamic drives, through the internal chamber of the hydrodynamic drives, and out the outlet valve at a distal end. The control circuitry is encased in Ecoflex (or other silicone rubber) within the central housing.

FIG. 8B shows the hydrodynamic drive-equipped “octopus-like” soft robotic system control head including 4 components (by volume): Turnigy Battery (7), Raspberry Pi (4)+Pi Sugar Battery (5)+Relays Control Board, Turnigy Battery Adapter Cable (10), and 5000 mAh power bank (8) for Turnigy Battery (7). A hexagonal tube (12) comprising Ecoflex (or other silicone rubber) can serve to both insulate (e.g., temperature wise) and protect (e.g., hermetically seal) the electronic control circuitry from the liquid environment.

FIG. 8C includes images of an actual prototype of a hydrodynamic drive-equipped “octopus-like” soft robotic system positioned on a wireless charging pad (top sub-figure in FIG. 8C) to charge the Ecoflex-encapsulated Turnigy battery, which powers the onboard Raspberry Pi Zero W computer and other electronic control boards.

The Ecoflex silicone rubber is slightly denser than water. As such, neutral buoyancy of the hydrodynamic drive-equipped “octopus-like” soft robotic system cannot be achieved without the addition of voids, i.e., hollow and/or gas-filled or liquid-filled encapsulated spaces inside the system (where the liquid used is less dense than water or in general the liquid of the environment the soft robotic system is operating in). This circumstance may preclude deployment at great depth because the voids would be compressed. However there are silicone rubbers that are less dense than water. Using these less dense silicone rubbers, neutral buoyancy can be achieved according to the Archimedes Principle by enlarging the volume of the hydrodynamic drive-equipped “octopus-like” soft robotic system (e.g., especially the head portion that houses the electronics and the onboard computer) to the point where the mass of the water or liquid displacement equals the dry mass of the hydrodynamic drive-equipped “octopus-like” soft robotic system. Given that this scenario would not make use of void encapsulated spaces inside the system (i.e., hollow and/or gas-filled or liquid-filled where the liquid used is less dense than water or in general the liquid of the environment the soft robotic system is operating in), deployment at arbitrary depths is possible.

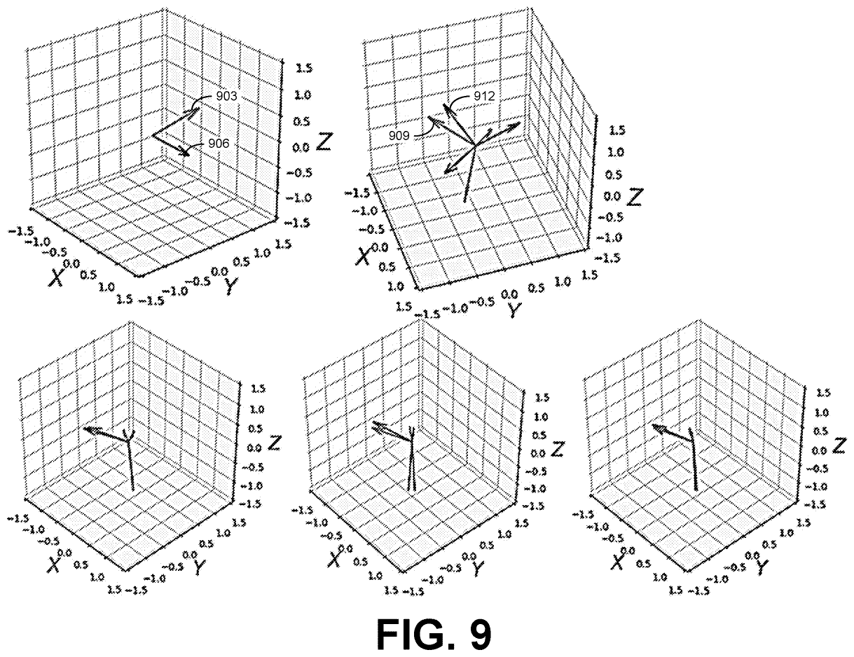

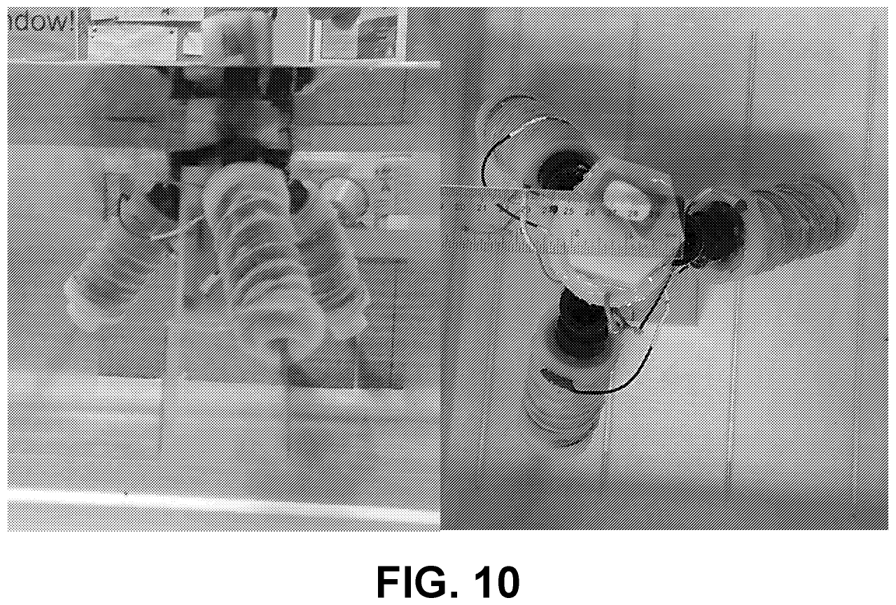

In one example, the hydrodynamic drive-equipped “octopus-like” soft robotic system can be rotated in space by commanding/activating the hydrodynamic drives using a quaternion rotation system, which is to say that it reads values from the absolute orientation fusion sensor BNO055 (as an example of an inertial measurement unit, or IMU), e.g., in real time, using a 4D vector, and uses this type of vector when computing calculations for vector rotation in 3D space. The advantage of quaternions over control schemes like Yaw, Pitch, and Roll or Euler angles is that an absolute reference frame can be maintained without being subject to gimbal lock. FIG. 9 shows examples of “firing”/activation schemes to effectuate rotations and directional/translational changes of the soft robotic system via its hydrodynamic drives. The top left plot shows initial heading (red 903) and target position (blue 906) vectors. The top right plot shows initial thrust vector positions (red 909) and possible final thrust vector positions (blue 912). The bottom plots (left to right) are a visualization of successive application of quaternion rotation to the soft robotic system to align the heading vector with the target position vector. Other control methods for reorientation or rotation of the hydrodynamic drive-equipped “octopus-like” soft robotic system may be known to the ones skilled in the art. FIG. 10 includes images showing an actual firing or activation of a soft robotic system with a triangular “octopus-like” arrangement of hydrodynamic drives.

Advantages over state-of-the-art of a hydrodynamic drive-equipped “octopus-like” soft robotic system can include, e.g.:
Pressure-resistance (immunity to high pressure): A hydrodynamic drive-equipped “octopus-like” soft robotic system that is completely liquid filled (e.g., potentially an open system that is in direct contact with the ambient water/liquid (i.e., no pressure differential) with no internal cavities, hollow structures, or voids may be deployable at arbitrary depths, because it would not experience hull pressure that would limit the deployment depth, which is currently the case, e.g., with submarines or submersibles.
Temperature-resistance (immunity to low temperatures): The soft robotic system does not use a motor or actuator. As such, the robotic system can operate in a wide range of liquid environments, including, but not limited to, liquid environments characterized by very low temperatures, e.g., as can be found in terrestrial oceans and on ocean worlds, e.g., Europa, Enceladus, Titan, etc.
Silent propulsion: An hydrodynamic drive-equipped “octopus-like” soft robotic system using this propulsion method does not generate sound (e.g., cavitation).
Attenuated heat signature: A hydrodynamic drive-equipped “octopus-like” soft robotic system using this propulsion method has a very attenuated heat-signature as, e.g., a large ocean acts as an infinite heat bath to completely absorb and thereby hide the local periodic heating of the hydrodynamic drive thereby severely attenuating the heat signature, especially over short distances, i.e., rapid temperature drop-off.
   Given the above, this hydrodynamic drive can provide an undetectable or relatively undetectable propulsion platform. Moreover, it can be used as, e.g., a propulsion system for marine applications or an implantable pump for medical/biomedical applications since both the silicone rubber and the nitinol are largely biocompatible.

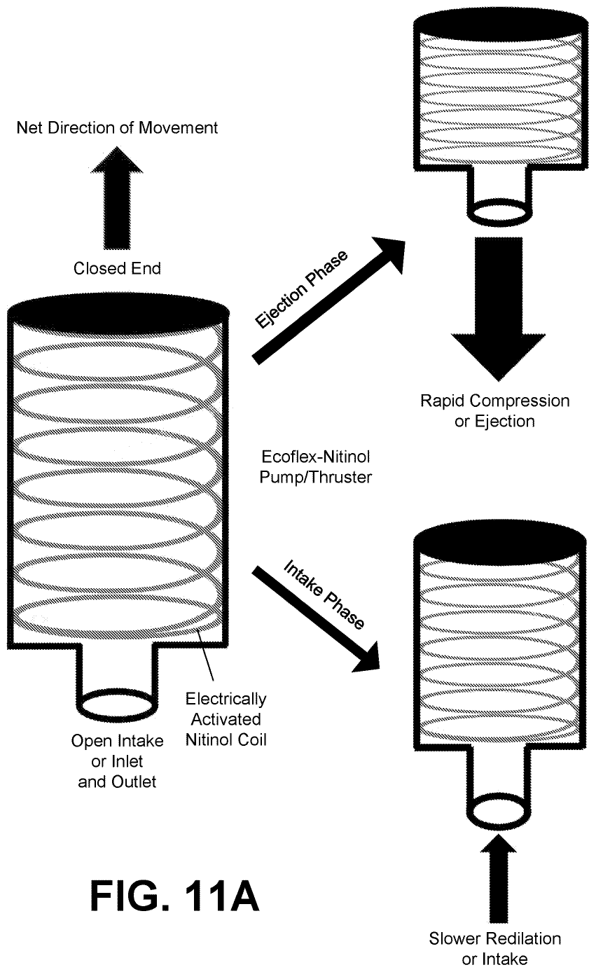

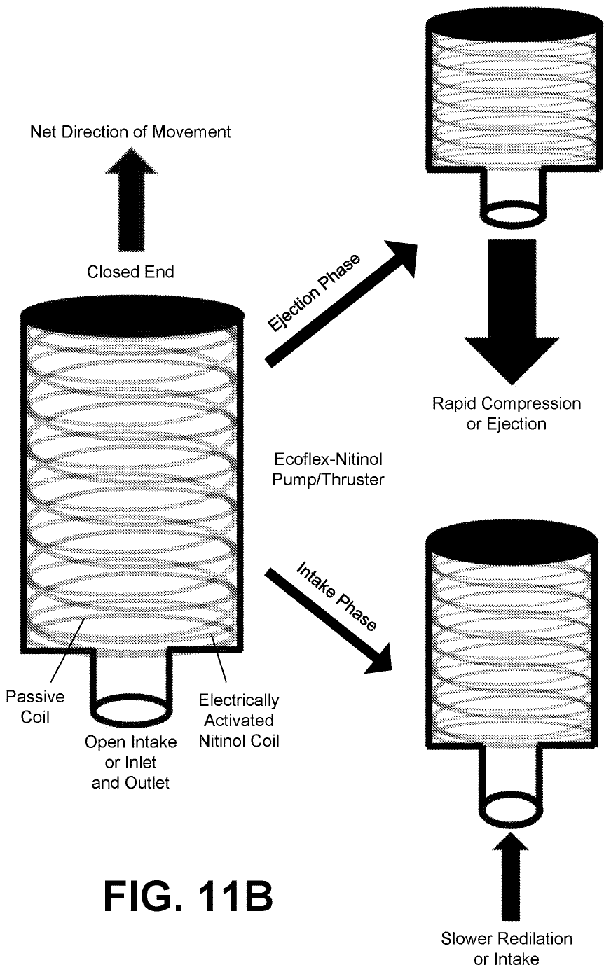

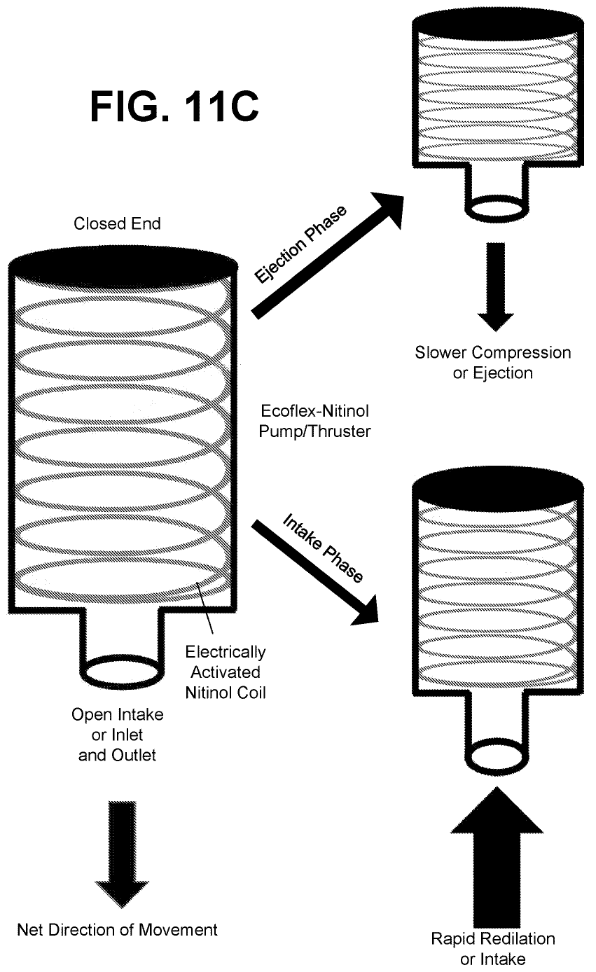

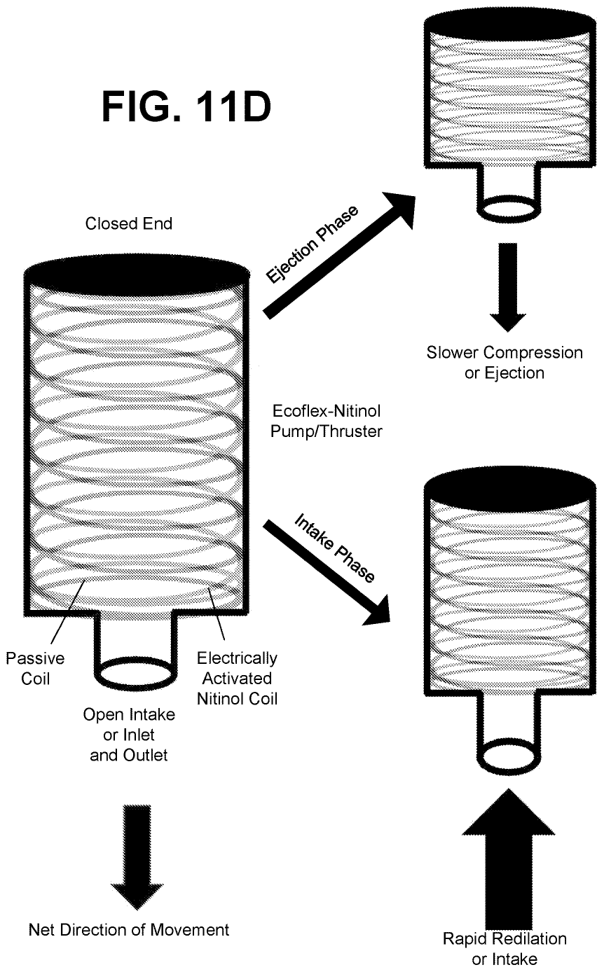

Referring to FIGS. 11A-11D, shown is another example of a hydrodynamic drive with a single opening that serves as both inlet and outlet, as well as the operation of this hydrodynamic drive. One end of the flexible body includes an opening while the other end is closed off thereby providing a single-opening pump/thruster. Net thrust with a single-opening hydrodynamic drive can be achieved by the difference in contraction vs. redilation speed of the electrically or thermally actuated coil. FIG. 11A illustrates a hydrodynamic drive comprising a single electrically or thermally actuated coil only. Here, the net thrust and its direction, as indicated, is effectuated by a rapid compression of the hydrodynamic drive during the ejection phase, followed by a slower (compared to the compression) redilation during the intake phase. In essence, the hydrodynamic drive mainly propels itself through the ejection phase, i.e., moving forward. FIG. 11B illustrates a hydrodynamic drive comprising one electrically or thermally actuated coil and a passive coil (or, alternatively a second electrically or thermally actuated coil not shown). As before, the net thrust and its direction, as indicated, is effectuated by a rapid compression of the hydrodynamic drive during the ejection phase, followed by a slower but expedited/assisted redilation during the intake phase which overall is still slower compared to the compression. In essence, the hydrodynamic drive mainly propels itself through the ejection phase, i.e., moving forward.

FIG. 11C illustrates a hydrodynamic drive comprising a single electrically or thermally actuated coil only. Here, the net thrust and its direction, as indicated, is effectuated by a slower compression of the hydrodynamic drive during the ejection phase, followed by a rapid (compared to the compression) redilation during the intake phase. In essence, the hydrodynamic drive mainly propels itself through the intake phase, i.e., suction, which essentially is the equivalent of a thrust-reversal, i.e., moving backwards. FIG. 11D illustrates a hydrodynamic drive comprising one electrically or thermally actuated coil and a passive coil (or, alternatively a second electrically or thermally actuated coil not shown). As before, the net thrust and its direction, as indicated, is effectuated by a slower compression of the hydrodynamic drive during the ejection phase, followed by a rapid but even more expedited/assisted redilation (compared to the compression) during the intake phase. In essence, the hydrodynamic drive mainly propels itself through the intake phase, i.e., suction, which essentially is the equivalent of a thrust-reversal, i.e., moving backwards. It should be noted that, through proper commanding (i.e., changing of compression and redilation timing), the hydrodynamic drive of FIGS. 11A-11D is capable of thrust-reversal, i.e., can go forward and backward. In contrast, the hydrodynamic drive of FIGS. 1A and 1B can only go in one direction, i.e., the same direction for both compression and redilation phases. However, the hydrodynamic drives of FIGS. 1A and 1B are not dependent on differences between compression and redilation speeds because of the dual valve system. In contrast, the hydrodynamic drives of FIGS. 11A-D are directly dependent on differences between compression and redilation speeds.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A hydrodynamic drive, comprising:
a flexible body having an interior chamber extending between a first end and a second end, the flexible body comprising an actuated helical coil extending between the first end and the second end, where activation of the actuated helical coil contracts the flexible body and deactivation of the actuated helical coil allows expansion of the flexible body.

2. The hydrodynamic drive of claim 1, wherein the first end is closed off and the second end comprises an opening.

3. The hydrodynamic drive of claim 1, further comprising:
inlet and outlet valves on the first and second ends of the flexible body, where the outlet valve is configured to allow discharge of fluid from the interior chamber of the flexible body during contraction and to prevent entrance of fluid to the interior chamber of the flexible body during expansion, and the inlet valve is configured to prevent discharge of fluid from the interior chamber of the flexible body during contraction and to allow entrance of fluid to the interior chamber of the flexible body during expansion.

4. The hydrodynamic drive of claim 1, wherein the actuated helical coil is electrically or thermally actuated.

5. The hydrodynamic drive of claim 1, wherein the flexible body comprises a second helical coil extending between the first end and the second end, wherein the second helical coil expands the flexible body when the actuated helical coil is deactivated.

6. The hydrodynamic drive of claim 5, wherein the second helical coil is a passive coil.

7. The hydrodynamic drive of claim 5, wherein the second helical coil is an actuated helical coil that is electrically or thermally actuated.

8. The hydrodynamic drive of claim 5, wherein the second helical coil is compressed by the actuated helical coil during activation and released when the actuated helical coil is deactivated.

9. The hydrodynamic drive of claim 5, wherein the actuated helical coil and the second helical coil are wound in opposite directions.

10. The hydrodynamic drive of claim 3, wherein the inlet and outlet valves are one-way valves.

11. The hydrodynamic drive of claim 10, wherein the inlet and outlet valves are duckbill valves.

12. The hydrodynamic drive of claim 3, wherein the inlet valve and outlet valve each comprise a backstop grating.

13. The hydrodynamic drive of claim 1, wherein the actuated helical coil comprises a shape memory alloy, wherein electrical or thermal activation of the shape memory alloy causes the actuated helical coil to contract from its initial shape and subsequent deactivation allows the actuated helical coil to return to its initial shape.

14. The hydrodynamic drive of claim 13, wherein the shape memory alloy is an electrically or thermally activated shape memory alloy.

15. The hydrodynamic drive of claim 6, wherein the passive helical coil is a steel spring or plastic spring.

16. A soft robotic system comprising at least one hydrodynamic drive of claim 1.

17. The soft robotic system of claim 16, wherein the at least one hydrodynamic drive operates as a pump or thruster.

18. The soft robotic system of claim 16, comprising a plurality of hydrodynamic drives.

19. The soft robotic system of claim 18, wherein the plurality of hydrodynamic drives are positioned in different orientations, wherein the plurality of hydrodynamic drives are individually controllable to provide directional thrust for propulsion or rotational thrust for reorientation of the soft robotic system.

20. The soft robotic system of claim 18, comprising control circuitry configured to individually control operation of each of the plurality of hydrodynamic drives.

21. The soft robotic system of claim 18, wherein the plurality of hydrodynamic drives are distributed in a triangular arrangement.

22-23. (canceled)

24. The soft robotic system of claim 16, comprising control circuitry configured to control operation of the at least one hydrodynamic drive based at least in part upon sensed orientation or location of the soft robotic system.

25. The soft robotic system of claim 24, wherein the control circuitry comprises an orientation sensor, a temperature sensor, and a pressure sensor.
